(19) United States
(12) Patent Application Publication
(10) Pub. No.: US 2020/0340270 A1
(43) Pub. Date: Oct. 29, 2020

(54) Automatic Door Knob Disinfector

(71) Applicant: Rajwan Mohammad Arif, Casa Grande, AZ (US)

(72) Inventor: Rajwan Mohammad Arif, Casa Grande, AZ (US)

(73) Assignee: SnowCart, LLC., Casa Grande, AZ (US)

(21) Appl. No.: 16/923,124

(22) Filed: Jul. 8, 2020

(51) Int. Cl. E05B 1/00

(52) U.S. Cl. CPC E05B 1/0069

(57) ABSTRACT

When we understand the risk we are taking by not having a device that can disinfect the door knob automatically. We find that we could potentially get in contact many very deadly germs. The automatic door knob disinfector has the ability to spray and project disinfecting liquid onto directly the door knob, providing a safe and sterilized knob without leaving any residue anywhere on the door. This ensures the safety and convenience of having a clean and sterilized knob. Especially in a pandemic where social distancing, washing hands, using hand sanitizer, wearing face mask is required this invention should help to lower the exchange of harmful germs especially since the door knob is the most physically touched part of the door.

### SUMMARY OF THE INVENTION

The invention invention will provide a proper sterilized, safe, and convenience use from many major issues. The most touched part of the door is the door knob in which humans can attract harmful germs. With major global issues such as COVID-19 the coronavirus infected millions of people with hundreds of thousands of deaths and counting. Most businesses have placed new measures to help prevent the spread of the coronavirus. Most common places have doors in placed from offices, homes, hospitals, airports, colleges, and schools. The invention will help in the effort for social distancing measures in all hope to slow down and stop the cause of the coronavirus and any future pathogens. The invention has a great safety ability of projecting (3) light directly onto the door knob providing the ability to see the key hole when visual lighting is an issue in which can lower the rate of crime in certain areas with high population where visual lighting is an issue. For example, after a long day at work you are on your way home and you are at your front door and visual lighting isn't sufficient which could lead to longer time of unlocking the door due to missing the key hole when visual lighting isn't sufficient, which could lead to a possible threat. Hospitals are in need for better solutions to provident harmful germs from spreading, the invention will automatically project disinfecting liquid onto the door knob providing a sanitary solution. Homes will benefit since most front doors of houses are usually mostly frequently touched, with the inventions easy set up within 5 seconds it's ready. The invention use will be beneficial to offices by providing safety from harmful germs and will benefit very much especially when sterilization is mostly needed in order to control the spread of harmful germs and viruses since most offices have employees which can be from 4 up to 500 people in average each employee has 3 members back home. In which could lead from 16 people to 2,000 people exchanging germs and viruses everyday due to unsterilized door knobs. The invention will provide a sterilizing solution and visual lighting issue. It ensures safety from harmful germs, bacteria's, and visual lighting. The invention is eco-friendly with (2) solar charging integrated directly on the top of the invention when placed on front door outside with sunlight projecting unto invention engaging automatic charging. The priority goal of the invention is to slow down to exchange of harmful germs which could lead to faster rate of a controlled environment.

### BRIEF DESCRIPTION OF THE DRAWINGS

FIG. 1 shows general front view layout of the (4) automatic door knob (1) disinfector.

FIG. 2 shows general front view layout of the (4) automatic door knob (1) disinfector with arrows indicating.

FIG. 3 shows use of invention with the liquid projecting onto the door knob providing a sterilized door knob.

FIG. 4 shows use of invention with details providing a safe and sterilized door knob by projecting disinfecting liquid onto the door knob.

### DETAILED DESCRIPTION OF THE DRAWINGS

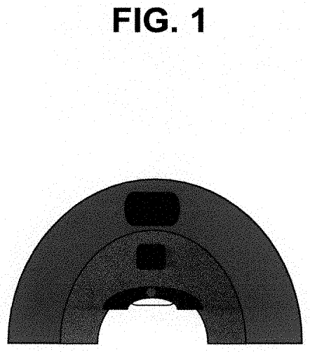

FIG. 1 shows a front view layout of the of the (4) automatic door knob (1) disinfector.

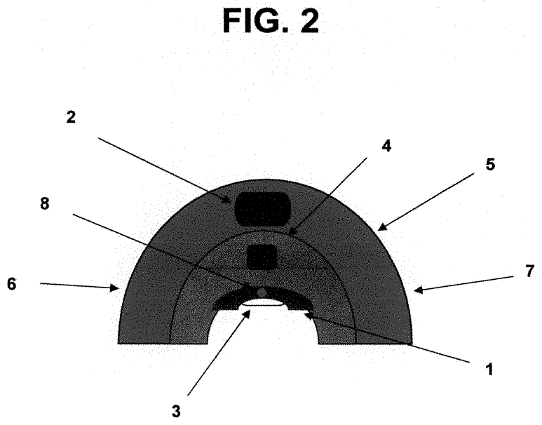

FIG. 2 shows a front view layout of the of the (4) automatic door knob (1) disinfector with arrows indicating.

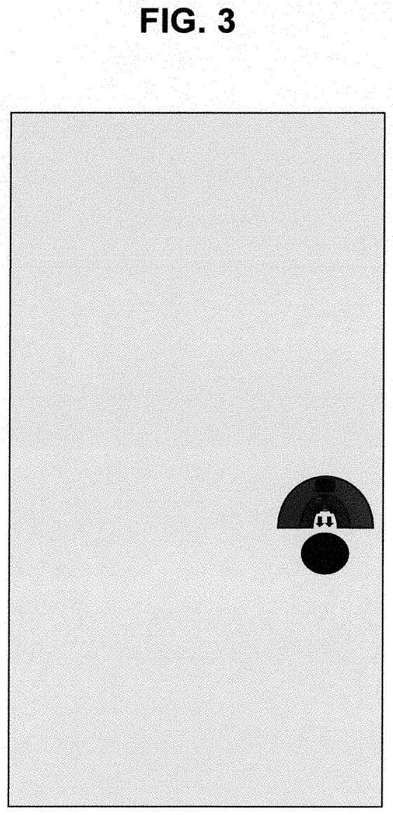

FIG. 3 shows a front view layout of the of the (4) automatic door knob (1) disinfector placed above the door knob projecting disinfecting liquid, making the door knob sterilized.

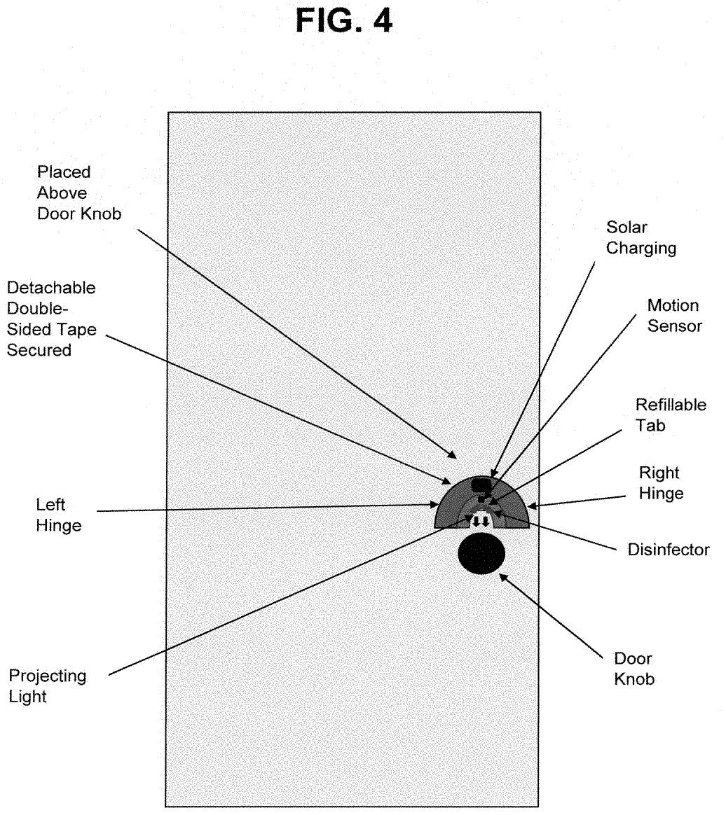

FIG. 4 shows the invention attached directly onto the door placed above the door knob. The invention has the ability to connect via applications de the ability to engage with user interfaced to project automatically disinfecting liquid onto the door knob. The invention shows the (6) left hinge & (7) right hinge used to adjust to the proper fitment depending on the space given from the door. The ability to be used in push pinned key for manual use of invention. It has (2) solar charging capabilities integrated for automatic charging when placed on an outside door. The invention shows many health benefits from harmful germs and bacteria's. The inventions priority goal is to slow down to exchange of harmful germs. In most common places where standard doors are present. The invention has the ability to disinfect the door knob while providing a convenient source of (3) lighting due to low visibility. The invention shows the (8) refillable tab which has the ability to be refilled when the disinfecting liquid is low. The invention has (5) double-sided tape to be secured in place onto the door for easy placement.

1. The (4) automatic door knob (1) disinfector to sanitize door knob.

2. The (4) automatic door knob (1) disinfector has the ability to allow multiple (4) automatic door knob (1) disinfectors to connect via device applications interfaced with invention to set preferable times to project liquid.

3. The (4) automatic door knob (1) disinfector has capability of (2) solar charging when place on an outside door with sunlight reflecting on the invention from sunrise to sunset from set angles.

4. The (4) automatic door knob (1) disinfector has capabilities of reflecting and projecting (3) light from the base of the invention directing down onto the door knob.

5. The (4) automatic door knob (1) disinfector has the ability to adjust to certain door fitment based on amount of space given with the adjustable (6) left hinge and (7) right hinge.

6. The (4) automatic door knob (1) disinfector has the capability of being attached and detached from the door for easy removal.
